(19) United States
(12) Patent Application Publication
(10) Pub. No.: US 2011/0004881 A1
(43) Pub. Date: Jan. 6, 2011

(54) LOOK-AHEAD TASK MANAGEMENT

(75) Inventors: Andrei Sergeevich Terechko, Eindhoven (NL); Ghiath Al-Kadi, Eindhoven (NL); Marc Andre Georges Duranton, Velhoven (NL); Magnus Själander, Goteborg (SE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/921,573

(22) PCT Filed: Mar. 12, 2009
(86) PCT No.: PCT/IB2009/051035

§ 371 Date: Sep. 9, 2010

(30) Foreign Application Priority Data
Mar. 12, 2008 (EP) 08102525.6

(51) Int. Cl. G06F 9/46

(52) U.S. Cl. 718/102

(57) ABSTRACT

A method comprising receiving tasks for execution on at least one processor, and processing at least one task within one processor. To decrease the turn-around time of task processing, a method comprises parallel to processing the at least one task, verifying readiness of at least one next task assuming the currently processed task is finished, preparing a readystructure for the at least one task verified as ready, and starting the at least one task verified as ready using the ready-structure after the currently processed task is finished.

### FIELD OF THE INVENTION

The present application relates to a method comprising receiving tasks for execution on at least one processor, and processing at least one of the tasks within one processor. The application further relates to a task management unit comprising input means for receiving tasks for execution on at least one processor, a microprocessor comprising a storage for storing task information, a system with a task management unit and a microprocessor, as well as a computer program comprising instructions operable to cause a task management unit to receive tasks for execution on at least one processor.

### BACKGROUND OF THE INVENTION

The current trend in computer architecture is to use more and more microprocessors, a.k.a. cores, within one chip for processing tasks in parallel to increase application performance. In particular in embedded domain systems, where multi-core solutions are common, the application performance is increased. In order to utilize the increased processing power of multi-core solutions, it is necessary to partition the programs into tasks that can be run in parallel on separate cores.

It is apparent that the more tasks are processed in parallel, the more the overall performance is accelerated. As the numbers of cores increases in multi-core solutions, it becomes necessary to partition applications into more and more smaller tasks, in order to keep all the cores busy and to accelerate application performance. The creation and distribution of tasks, a.k.a. task scheduling, has commonly been handled by software. However, as tasks become smaller and increase in number, a task schedule being performed by software introduces overheads in view of data transfer and processing of the scheduling. This will decrease the efficiency of parallel task processing.

In particular the code for managing task scheduling might become a bottle neck for a huge number of small tasks. The code for managing tasks is generally simple, consisting of arithmetic operations such as addition, subtraction, comparing, branching, and atomic loads and stores. The parallel processing requires checking dependencies of tasks, e.g., whether one task can be started or not depending on other tasks that might be necessary to be executed beforehand. Therefore, dependencies of tasks need to be updated for each finished task, such that other tasks can become ready to be executed. If the dependency check is executed after a task has finished and the dependencies has been updated, the current dependency state is known. This allows for verifying, which tasks can be executed. However, the dependency check can introduce delays, since the check is performed before the next task can be executed.

In particular for a plurality of tasks, architectures with task queues are known. In this type of architectures, the execution of a task is followed by a piece of code for updating dependencies and checking for a task ready status or not.

FIG. 1 illustrates a commonly known dependency check with twelve different tasks 2, 4, 6, 8. On a first core 10, tasks 2a-2c are executed. On a second core 12, tasks 4a-4c are executed. On a third core 14, the tasks 6a-6c are executed. And on a forth core 16, the tasks 8a-8c are executed. Thus, twelve different tasks 2, 4, 6, 8 are executed on four separate cores 10-16. After completion of each task 2-8, a task dependency check 18 is executed.

In FIG. 1, for reason of simplicity, it is assumed that each task is identical in execution time. As can be seen, the dependency check operation 18 consumes time, within which the cores 10-16 are not operative, i.e. do not process a particular task. For example, for a video decoder under the H.264 standard, it has been found that the dependency check operation 18 increases the overall task execution time by 9% on average. This results in the embodiment according to FIG. 1 in a requirement of one complete core for managing the dependency check for every eleven other cores in the architecture.

For the reasons set forth above, it is an object of the present application to increase performance of processing of applications that have task dependencies, i.e. in multi-core architectures. It is another object to increase image and video decoding speed by parallel task processing. A further object is to reduce die size by reducing dependency check overhead. Another object is to increase energy efficiency by reducing the number of required processors for parallel processing.

### SUMMARY OF THE INVENTION

These and other objects are solved by a method comprising receiving tasks for execution on at least one processor, processing at least one of the tasks within one processor, parallel to processing the at least one task, verifying readiness of at least one next task assuming the currently processed task is finished, preparing a ready structure for the at least one task verified as ready, and starting the at least one task verified as ready using the ready-structure after the currently processed task is finished.

By verifying the readiness of at least one next task assuming the currently processed task is finished parallel to processing at least one task, allows for immediate starting the execution of the next task upon finishing a currently processed task. While a task is being executed, it may be possible to find out what dependencies will be solved by the currently executed task by assuming that the currently executed task is finished. This allows for verifying, whether a next task is ready or not, prior to finishing the processing of the currently processed task. If there are tasks that only depend on the currently executed task, they will be ready for execution, once the currently executed task is finished. In order to provide for immediate starting the ready tasks, these could be prepared for execution by a task management unit, such that once the current processor (core) finishes the current execution, the next task can start. Dependencies can be updated in parallel with the execution of the task, thus decreasing task execution time.

During the execution of the task, it may be possible to find all tasks that depend on the currently executed task. All found tasks may then be marked as candidate tasks to be executed by the processor.

According to embodiments, verifying the readiness of at least one next task may comprise checking task dependencies between the at least one received task, and the currently processed task. This allows for checking, as a look ahead technique, whether at least one of the received tasks may be ready for execution, once the currently processed task is finished, in parallel with the actual execution of the task. If the at least one received task, which is not executed yet, only depends on the currently processed task, it can be marked as ready even during execution of the currently processed task. This look-ahead technique provides for reducing the start time of the received tasks after the currently processed task is finished.

According to embodiments, it may be possible, to store within a task queue at least one of the ready-structures of tasks and/or the task verified as ready. For example, in architectures, which have more than one core, in particular in architectures that are scalable to more than a few cores, several processors may verify the readiness of at least one next task. The results of this verification can be a plurality of tasks in the ready stage. This at least one ready task can be stored in the task queues. The task queues do provide information about tasks in the ready state which are currently not being executed by a processor. This way, tasks may be distributed between different cores. The distribution of task queues allows for storing information about ready tasks within a scalable architecture.

According to embodiments, the ready-structure may comprise at least one of a function pointer and/or an argument list. The function pointer may point to the first instruction of the task being verified as ready. The argument list may comprise information about arguments for the task to be executed.

According to embodiments, the argument list may be used for a data prefetching. By performing data prefetching, the arguments for the task to be executed next may already be fetched during the currently processed task is processed, allowing the next task to start immediately after the currently processed task is finished.

It may also be possible that some tasks are not ready, even if the currently processed task is finished. This may be because of further dependencies, e.g. the task is dependent on other tasks than the currently processed task. In order to account for such tasks, a partially-ready-structure for at least one task which is not verified as ready is provided. The partially-ready-structure allows for providing information about task dependencies of tasks which are not ready in the next processing sequence.

According to embodiments, the partially-ready-structure may comprise information about task dependencies being not met. Thus, if dependencies have not been satisfied, the dependencies may be stored in the partially-ready-structure. It may be possible that after the started regular task ends, the unsatisfied dependencies being stored in the partially-ready-structure are checked. This way dependencies already satisfied during the execution of the current tasks will not delay next task creation. The verification of the partially-ready-structure may be possible with a reduced software overhead.

According to embodiments, verifying readiness of at least one task within a partially-ready-structure after a currently processed task is finished is possible.

To keep track of candidate tasks and speed up the turn around time of executed tasks, a processor may comprise, according to embodiments, a dedicated storage area may hold necessary information about candidate tasks, i.e. tasks with a partially-ready-structure. Each processor may directly access the information about the tasks to be executed. The dedicated storage may also hold information about ready tasks, i.e. with a ready-structure. It may also be possible.

According to embodiments, the task information may comprise at least one of a task pointer, a look-ahead pointer, a dependency pointer, an argument pointer, or a flag. The task pointer may hold information about the instruction address of the first instruction of the task. The argument pointer may hold the address to where arguments for the tasks are stored. The look-ahead pointer may comprise information about a look-ahead function to be executed if the task will be executed by the core. This function may allow for calculating and determining, which dependencies are resolved, when the currently processed task is executed. A dependency pointer may hold the address to a memory location that stores the number of dependencies that still have to be resolved before the task can be executed. A flag may be used for synchronizing the processor with a task management unit. The information about the task stored in the processor allows for speeding up the turn around time between tasks being executed. The flag may allow for calculating and determining, which dependencies are resolved, when the currently processed task is executed. The flag may be one bit used for synchronizing between the task management unit and the processor. The flag may also comprise several bits, indicating, for example, the state of a task, the time of processing, i.e. while it is executed. If a task is ready for execution, then the task pointer and argument pointer will be read and the processor can start the execution of the new task. The task management unit can then, in parallel with the execution of the task, decrement the value given by the dependency pointer for all the tasks not being executed. In case there is no ready task, when the processor finishes with a currently processed task, it can wait until task dependencies are updated and a task becomes ready for execution. The speed-up of verifying a ready status may be achieved in that only the dependencies of candidate tasks not found ready for execution by the look-ahead function need to be updated. The look-ahead function may check, which tasks may be necessary in the future. If these tasks are dependent on the currently processed task, their dependency can be updated. If tasks are ready, no update is necessary. Therefore, the look-ahead function reduces the number of dependency checks.

According to embodiments, dependency information for tasks from the current task may be obtained from the task information.

Another aspect is a task management unit comprising input means for receiving tasks for execution on at least one processors, verifying means arranged for verifying readiness of at least one next task, assuming the currently processed task is finished, parallel to processing the at least one task, preparation means arranged for preparing a ready-structure for the at least one task verified as ready, and output means for putting out the ready structure after the currently processed task is finished for starting the at least one task verified as ready.

A further aspect is a microprocessor comprising a storage for storing task information, where the storage comprises a memory area for storing a task pointer, a storage area for storing an argument pointer, and a storage area for storing a dependency pointer.

According to embodiments, access means may be provided for providing access to the storage for storing task information using a task management unit of as previously described.

Another aspect is a system with a task management unit and a microprocessor as previously described.

A further aspect is a computer program comprising instructions operable to cause the task management unit to receive tasks for execution on at least one processors, provide the task for processing to at least one processor, parallel to processing the at least one task verify readiness of at least one next task assuming the currently processed task is finished, prepare a ready-structure for the at least one task verified as ready, and starting the at least one task verified as ready, using the ready structure after the currently processed task is finished within the processor.

### BRIEF DESCRIPTION OF THE DRAWINGS

FIG. 1 illustrates task execution for a conventional architecture;

FIG. 2 an illustration of dependencies between macro-blocks within a video compression standard;

FIG. 3 an illustration of a task dependency graph;

FIG. 4 an illustration of execution of tasks according to embodiments;

FIG. 5a a ready structure for a task;

FIG. 5b a partially-ready structure for a task;

FIG. 6 an illustration of an architecture with several processors and several task management units;

FIG. 7 an illustration of task information;

FIG. 8 a schematic illustration of a task management unit.

### DETAILED DESCRIPTION OF THE DRAWINGS

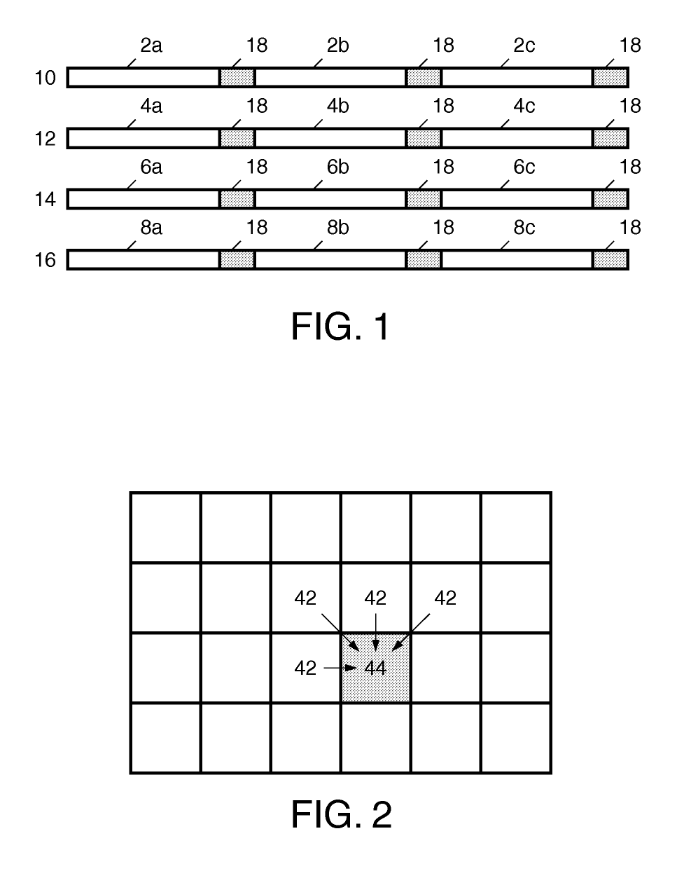

As has been mentioned above, in combination with description of FIG. 1, in multi-processor, a.k.a. multi-core, solutions, a plurality of tasks need to be processed in parallel, which might lead to processor contention and ineffective task processing. In particular in the multimedia domain, the partitioning of an application will commonly introduce the dependencies between tasks. The dependencies between tasks force the tasks to be executed in a certain order to meet these dependencies. For example, such dependencies can be found in a video decoder, for example a H.264 video decoder. In such a video decoder, a high amount of tasks needs to be processed, with a lot of dependencies, which poses a task management problem. Task dependencies need to be monitored and need to be checked when a task is ready to be executed. The algorithms for dependency checking are often not complex, but they can introduce large overhead. For example, in a super HD H.264 decoder, 9% of the execution time is consumed by checking task dependencies and task management.

When processing tasks in parallel, it needs to be distinguished between tasks that are dependent and tasks that are not dependent. For example, for parallel video decoding with macro-blocks and spatial-temporal motion prediction, parallel tasks introduce dependencies. This kind of applications differ from other parallel work loads, such as server work loads with multiple incoming requests, desktop work loads consisting of multiple programs, and scientific work loads, where the tasks are commonly independent of each other and can be executed randomly. However, for applications with inter-task dependencies, the execution order is crucial for correct application behavior. The execution order cannot always be totally statically determined at compile time, because of variations in computational load, task execution time and load balancing. Hence, a dynamic task management at run time is necessary, as is introduced by the present embodiments.

One example of task parallelism is video decoding, such as H.264 video decoding. Such a decoding will be exemplarily described herein after.

H.264 video decoding in super HD requires a multi-core architecture, to reach the performance necessary for decoding 30 to frames per second. For video decoding, each frame being decoded is first entropy decoded, consisting of either context-adaptive binary arithmetic coding or a context-adaptive variable length coding, which both are sequential by their natures. A frame is then passed on to a picture prediction stage, where each frame is divided into macro blocks, for example 16 times 16 pixels. For each macro block, inter-picture prediction and motion vector estimation is calculated. The frame is then filtered through a deblocking filter to reduce artifacts from the picture prediction stage at block boundaries. The resulting frame has then been decoded and can be passed onto the display.

The picture prediction and deblocking filter is suitable for parallelization, where the execution of the macro-block can be treated as a task. Such execution is illustrated in FIG. 2. As can be seen, there are several macro blocks 42 at boundaries to a macro block 44. In order to process picture prediction and deblocking of macro block 44, it is necessary that macro blocks 42 are executed before macro block 44 is filtered. By that, macro-block 44 cannot be executed before macro-blocks 42 have been executed. This introduces task dependencies, as the tasks for filtering macro block 44 require the prior execution of filtering of macro blocks 42.

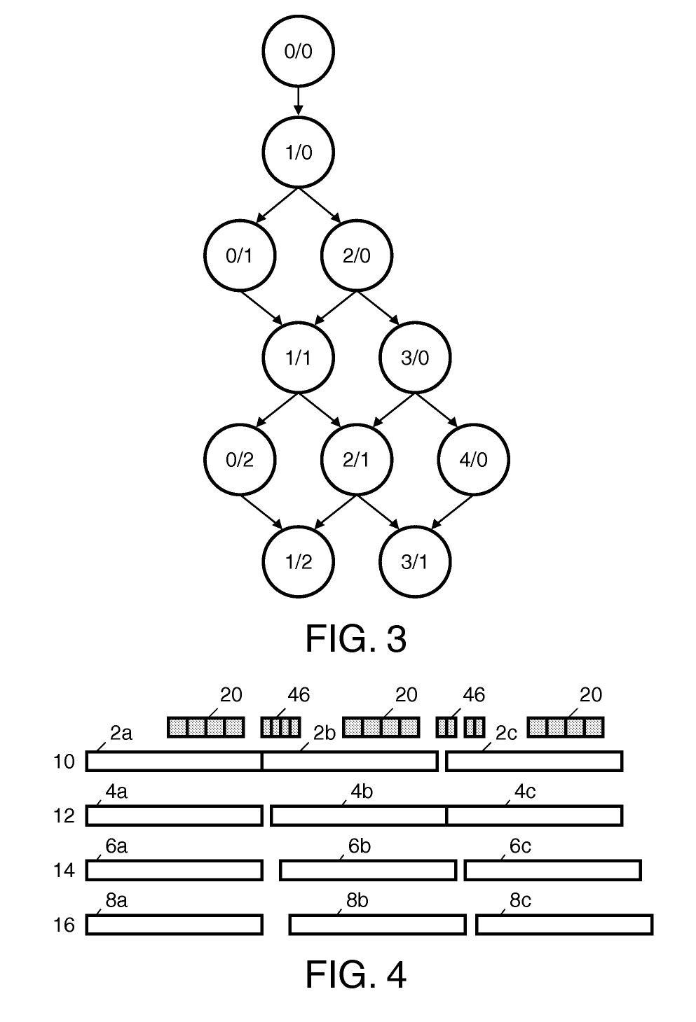

Such a task dependency can be illustrated in a graph, for example as illustrated in FIG. 3. The graph of FIG. 3 illustrates several tasks 0/0-4/4, which can be dependent on certain other tasks. As can be seen in FIG. 3, a first task 0/0 is independent. However, the second task 1/0 can only start, when the first task 0/0 has been executed. Each of the new tasks can potentially start the execution of one or two other tasks, for example, after task 1/0, both tasks 2/0 and 0/1 can start. These task dependencies, as illustrated in a graph of FIG. 3, can be tracked by storing the number of tasks that each task depends on. For each finished task, this value of task dependencies can be updated. The task can execute, once its value of dependencies becomes zero.

In order to provide parallelism, there is provided a look-ahead task management unit, capable of execution of task-dependency checks in parallel with the execution of the tasks. Each task management unit can offload dependency checks and dependency updates from a number of conventional processors and can try to schedule dependent tasks onto these processors. The distribution of tasks between various task management units can be done through a task queue. By executing the task-dependency checks in parallel with the conventional processing of the tasks, a total execution time speed-up of 4.5% for a multi-processor architecture for video decoding can be achieved.

Such a parallel task dependency check is illustrated in FIG. 4. In FIG. 4, there are illustrated tasks 2, 4, 6, 8, a readiness verifying stage 20, and a task dependency update 46. The twelve tasks 2a-2c, 4a-4c, 6a-6c, 8a-8c are being executed on four different cores 10-16. For each task 2, 4, 6, 8, within the verifying stage 20, in parallel to processing the tasks, a look-ahead code is being executed for verifying, whether these tasks provide for readiness of a consecutive task. In the illustrated example, in the verifying stage 20, for the first task 2a, executed on processor 10, a candidate task 2b was found with its dependencies fulfilled. This second task 2b can be started immediately, once processor 10 finishes the current execution of task 2a. Task dependency update 46 updates dependencies of tasks, and after a task dependency update was executed, the tasks 4b, 6b, 8b could be executed. However, the task dependency update 46 is much faster than the verifying stage 20, thus allowing tasks 4b, 6b, 8b to be executed a lot closer in time to the finalization of a previous task.

Further, the second verifying stage 20 determines that task 4c is ready right after task 4b has been finished. Thus, on the second processor 12, task 4c is started immediately after task 4b is finalized.

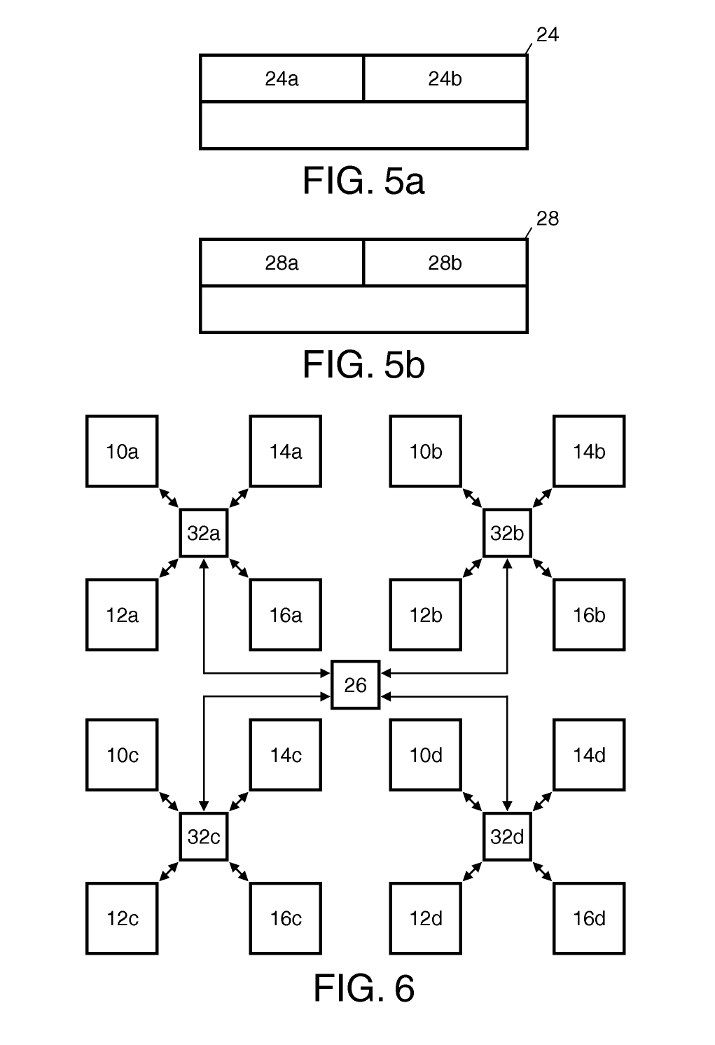

In the verifying stage 20, task ready structures 24, as illustrated in FIG. 5a, are created. Task ready structures 24 may comprise a function pointer 24a and an argument list 24b. The function pointer and the argument list can be read, and the processor can execute the new task immediately. The task ready structure 24 may, though not illustrated, comprise also a look-ahead function pointer. Also, an argument pointer may also be comprised.

During the verifying stage 20, tasks may also be found as partially-ready. For these tasks, a partially-ready-structure 28, as illustrated in FIG. 5b can be created. The partially ready structure 28 may comprise a task pointer 28a, as well as information 28b about task dependencies being not met. These information 28b can be updated in step 46, as illustrated in FIG. 4, upon which a partial-ready-structure may indicate a task being executable.

The verification step 20 and the update step 46 can be processed within a task management unit, as illustrated in FIG. 6. The purpose of the task management unit 32 may be to offload the management of tasks from processors 10, 12, 14, 16 in a multi-core-architecture as illustrated in FIG. 6. While the tasks are being executed on the process source 10-16, the task management units 32 try to find tasks that are ready to be executed and have them prepared, so that a processor 10-16 can directly start executing a new task when it finishes their current task execution. For each task being executed, the task management unit 32 executes a function that looks ahead in time, in order to try to find tasks that will be ready for execution. When doing so, the task management units 32 assume the currently processed tasks on processors 10-16 being finished. As is illustrated in FIG. 6, a scalable architecture that connects several task management units 32 with a defined number of processors 10-16 allows for processing more look-ahead functions than with a single task management unit 32. Each task management unit 32 offloads the look-ahead control from the processors. Within a task queue 26, tasks that are found to be ready can be stored. This way, the task management units 32 may obtain information about tasks being ready within a task-ready structure 24 from task queue 26. This information allows for the processors 10-16 to execute tasks being found as ready using the task-ready structure.

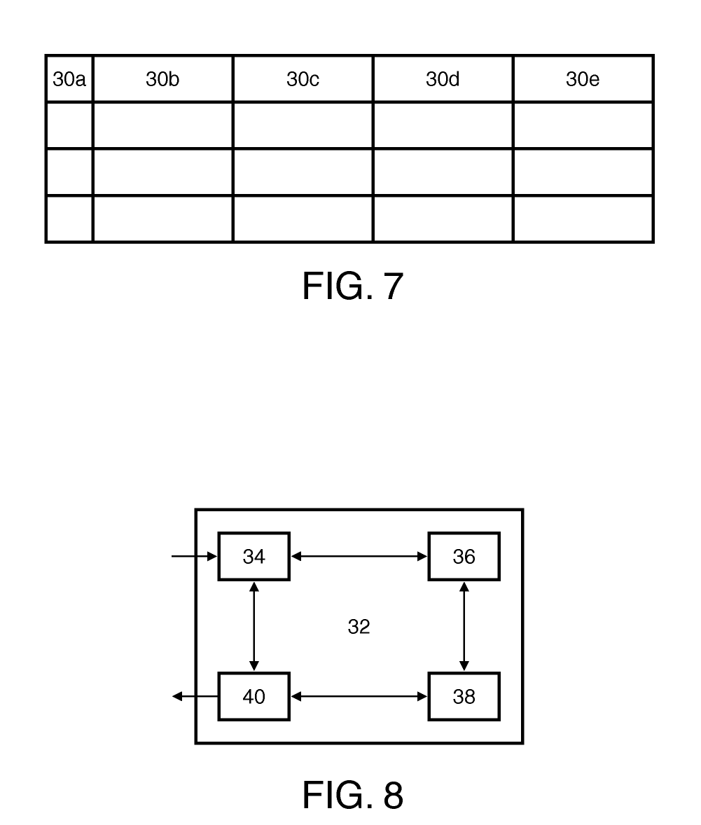

In order to decrease the turn around time between executed tasks, each processor 10-16 may have a dedicated task information 30 list as illustrated in FIG. 7 storing candidate tasks and the information for executing these tasks. This information can be a task pointer 30d, an argument pointer 30e, a look-ahead pointer 30b, a dependency pointer 30c, and a flag 30a. If there is a task ready for execution, the task pointer 30d and the argument pointer 30e can be read by the processor and execution can start. The task management unit 32 can then, in parallel with the execution of the task, decrement the value given by the dependency pointer for all the tasks not being executed. Only the dependencies of candidate tasks not found ready for execution by the look-ahead function of the task management unit 32 need to be updated, thus reducing the number atomic accesses for updating the information 30. The task management unit 32 may check the state of the task queue, the flag 30a of the information 30 for each core 10-16, and for incoming tasks and messages. If there is an idle processor 10-16 and a task being found ready in the task queue 26, the task can be fetched from the task queue 26, information 30 with a processor 10-16 can be updated, telling the processor 10-16 that the task is ready for execution. When a processor 10-16 finishes the execution of the task, a routine may first check for tasks that are ready for execution with an information 30. If these tasks are not executed by the processor 10-16 itself, these tasks can be stored in the task queue 26 for execution at a later time. Then, dependency values for tasks not ready to be executed can be decremented. Eventually, a look-ahead pointer 30b and an argument pointer 30c can be read from the task currently being executed by the core and the look-ahead function can be executed by the task management unit 32.

In order to perform the look-ahead function, a task management unit 32 may comprise, as illustrated in FIG. 8, input means 34 for receiving tasks for execution on at least one processors. Further, there may be provided verifying means 36 for verifying readiness of at least one next task, assuming the currently process task is finished parallel to processing the at least one task. The verifying means 36 may have access onto information 30 and may read the flags 30a and may update the dependency pointers 30c.

Further, there may be provided preparation means 38 for preparing the task ready structure as illustrated in FIG. 5a. Eventually, there may be provided output means 40 for putting out the ready-structure either to the task queue 26 or to the processors 10-16 into information 30.

By providing the parallel dependency checks, the execution time of parallel tasks may be significantly decreased. The cores may offload dependency checks to a task management unit. This enhances, for example video processing.

1. Method comprising:
receiving tasks for execution on at least one processor,
processing at least one of the tasks within one processor,
parallel to processing the at least one task, verifying readiness of at least one next task assuming the currently processed task is finished,
preparing a ready-structure for the at least one task verified as ready, and
starting the at least one task verified as ready using the ready-structure after the currently processed task is finished.

2. The method of claim 1, wherein verifying the readiness of the at least one next task comprises checking task dependencies between the at least one received task and the currently processed task.

3. The method of claim 1, further comprising storing within a task queue at least one of
the ready-structures of tasks, and
the tasks verified as ready.

4. The method of claim 1, wherein the ready-structure comprises at least one of:
a function pointer;
an argument list.

5. The method of claim 4, wherein the ready-structure comprises at least the argument list for data prefetching.

6. The method of claim 1, further comprising preparing a partially-ready-structure for at least one task which is not verified as ready.

7. The method of claim 6, wherein the partially-ready-structure comprises information about task dependencies being not met.

8. The method of claim 6, further comprising verifying readiness of at least one task within the partially-ready-structure after a currently processes task is finished.

9. The method of claim 1, wherein verifying readiness of at least one tasks within a partially-ready-structure comprises checking task dependencies being marked within the partially-ready-structure.

10. The method of claim 1, further comprising storing within at least one processor task information about tasks to be executed.

11. The method of claim 10, wherein the task information comprises at least one of
a task pointer,
a look-ahead pointer,
a dependency pointer,
an argument pointer, and
a flag.

12. The method of claim 10, further comprising obtaining dependency information for tasks from the current task from the task information.

13. Task management unit comprising:
an input adapted to receive tasks for execution on at least one processor,
a verifier adapted to verify readiness of at least one next task assuming the currently processed task is finished parallel to processing the at least one task,
a preparing unit that prepares a ready-structure for the at least one task verified as ready, and
an output that puts out the ready-structure after the currently processed task is finished for starting the at least one task verified as ready.

14. A microprocessor comprising:
a storage for storing task information, wherein the storage comprises;
a first memory area for storing a task pointer
a second memory area for storing an argument pointer and
a third memory area for storing a dependency pointer.

15. The microprocessor of claim 14, further comprising an access device adapted to provide access to the storage for storing task information using a task management unit of claim 13.

16. A system comprising:
a task management unit of claim 13, and
a microprocessor including a storage for storing task information, wherein the storage has:
a first memory area for storing a task pointer,
a second memory area for storing an argument pointer and
a third memory area for storing a dependency pointer.

17. A computer program comprising instructions operable to cause a task management unit to
receive tasks for execution on at least one processor,
provide the task for processing to at least one processor,
parallel to processing the at least one task, verify readiness of at least one next task assuming the currently processed task is finished,
prepare a ready-structure for the at least one task verified as ready, and
start the at least one task verified as ready using the ready-structure after the currently processed task is finished within the processor.
